(19) United States
(12) Patent Application Publication
(10) Pub. No.: US 2016/0004802 A1
(43) Pub. Date: Jan. 7, 2016

(54) Multiscale Modelling of Growth and Deposition Processes in Fluid Flow

(71) Applicants: Marcus Herrmann, Scottsdale, AZ (US); Yajing Gale, Mesa, AZ (US)

(72) Inventors: Marcus Herrmann, Scottsdale, AZ (US); Yajing Gale, Mesa, AZ (US)

(73) Assignee: ARIZONA BOARD OF REGENTS ON BEHALF OF ARIZONA STATE UNIVERSITY, Scottsdale, AZ (US)

(21) Appl. No.: 14/790,867

(22) Filed: Jul. 2, 2015

Related U.S. Application Data
(60) Provisional application No. 62/020,677, filed on Jul. 3, 2014.

(51) Int. Cl. G06F 17/50; G06F 17/10

(52) U.S. Cl. CPC G06F 17/5009; G06F 17/10

(57) ABSTRACT

A multiscale procedure models the growth of fluid-suspended particles through phase transition and/or agglomeration. The particle deposition on fluid flow boundaries and the precipitation occurred on the solid/liquid interface will influence and potentially constrict/block the fluid flow. The multiscale Lagrangian/Eulerian model enables detailed predictive simulations of the deposit formation and aging processes due to the continued precipitation on the deposit interface and deposition processes of precipitated solids, such as wax crystals or asphaltenes, on boundaries like walls exposed to fluid flow.

### CROSS-REFERENCE TO RELATED APPLICATIONS

This application claims the benefit of U.S. Provisional Application No. 62/020,677 filed Jul. 3, 2014, which is incorporated herein by reference in its entirety.

### STATEMENT OF GOVERNMENTAL SUPPORT

This invention was made with government support under 0932968 awarded by National Science Foundation. The government has certain rights in the invention.

### FIELD OF THE DISCLOSURE

The present invention relates to a molecular agglomeration model and more particularly relates to an apparatus, a system and a method for modeling and predicting wax and asphaltene buildup within oil pipelines.

### BACKGROUND

Crude oil is a mixture of a diverse group of species. At reservoir temperature and pressure (e.g., 70-1500° C., 50-100 MPa), the molecules of the high molecular weight paraffin are dissolved in the crude oil. The paraffinic groups with high carbon numbers have high crystallization temperatures and may crystallize even at low concentration in the crude oil. These crystallites are referred to as waxes, and the temperature at which crystallization starts is referred to as the wax appearance temperature (WAT).

When crude oil temperature drops below the WAT, the high molecular weight paraffin components precipitate from the oil and crystallize. The flocculation of orthorhombic wax crystallites leads to the formation of gels with complex morphology. In a pipeline, the gels can be deposited onto the cold pipeline inner walls to form a solid wax phase (see FIG. 1). Wax deposition can severely reduce flow rate, and can even cause total blockage of a pipeline.

As on-shore oil fields are being rapidly depleted, oil wells are drilled further offshore in deep water, which require long distance sub-sea pipelines to transport crude oil on-shore. Crude oil produced by deep water wells have significant wax and asphaltene content that can precipitate from the petroleum inside underwater pipelines due to local cooling and pressure drops. The solid wax crystals or asphaltenes can deposit on the inside of the pipeline wall and over time block the flow in the pipe, requiring expensive cleaning procedures. Wax deposition becomes much more severe and extensive for such operations due to very low ocean floor temperatures.

There have been extensive efforts in the last decade to understand wax formation and deposition mechanisms, and to develop models for wax deposition predictions. Local equilibrium models, which are purely thermodynamic in nature, have been proposed for predicting the onset of crystallization (wax precipitation) and solid-liquid phase equilibria for crude oils (Won, 1986, 1989; Pedersen, 1995; Lira-Galeana et al. 1996). Modeling wax formation and deposition in the presence of strong flow, heat and mass transfer in a pipeline, however, poses a significant challenge due to the complicated couplings among various physical effects. A sound understanding of the mechanisms responsible for the transport of the wax, in both liquid and solid phases, from the bulk of the fluid to the pipe wall is essential.

The temperature distribution in the pipeline determines the location where precipitation of wax crystals will take place. If the temperature near the pipe wall is below WAT, deposits will form. These deposits will continue to grow and may become immobilized on the pipe wall. WAT can also appear in the bulk of the fluid. In this case, wax crystals formed in the bulk may migrate to the wall as particles, agglomerate and be retained there; or they may be transported to hotter regions where the concentration is below the solubility limit and be redissolved into the oil (Azevedo & Teixeira, 2003).

The deposition of the wax in particulate state is controlled by mechanisms such as Brownian diffusion, shear dispersion and gravitational settling. Results from laboratory loop experiments carried out under the special condition of zero heat flux from the pipe wall to the fluid show that particulate deposition is not significant (Burger et al. 1981; Weingarten & Euchner 1986; Brown et al. 1993; Singh et al. 2000). This has led to the conclusion that particulate deposition is generally not relevant for wax deposition (Singh et al. 2000). This conclusion is based on the notion that if there is no particulate deposition in the absence of a radial temperature gradient, then there will be no particulate deposition in the presence of a radial temperature gradient. There has been no direct evidence suggesting this is true for non-zero heat flux conditions, however.

It is believed that the wax particulates/crystallites form an immobile wax-oil mixture with significant amount of oil trapped in a 3D network structure of the wax crystals. Continued precipitation and growing of the wax content in the gel due to molecular diffusion are often suggested as the main cause of deposition (Brown et al. 1993; Hamouda & Davidsen, 1995; Creek et al. 1999). This view, however, is challenged by a further examination of experimental data (Azevedo & Teixeira, 2003), which indicates that under certain operating conditions, molecular diffusion deposition might not be the predominant deposition mechanism, and particulate deposition could be important.

Despite the growing/aging nature of the gel layer, many existing models assume a constant wax content in the gel layer (Sevendsen, 1993; Singh et al. 2000, 2001; Hernandez et al. 2004). This constant wax content is arbitrarily adjusted so that the model “prediction” fits the experimental data.

In addition, most studies adopt questionable assumptions (Sevendsen 1993; Elphingston et al. 1999; Singh et al. 2000, 2001; Ramirez-Jaramillo et al. 2004; Lira-Galeanan et al. 1996). Axial temperature variation has been neglected; essentially axial velocity profiles obtained from power-law correlations are used, which are only valid for nearly flat wax layers and away from the developing flow region near the pipe entrance. The radial velocity in the gel layer has been routinely neglected based on the argument that its magnitude is much smaller than the axial velocity (Singh et al. 2000). However, the non-uniform, axially-developing wax deposition induces significant variations in radial velocity, and its contribution to the species flux in the radial direction may be comparable to radial diffusion. Banki et al. (2008) and Hoteit et al. (2008) addressed some of these deficiencies for laminar flows. They also employed more accurate multi-solid wax precipitation and a multi-component diffusion flux in their model. However, thermal and molecular diffusions in the axial direction are still neglected, and deposition of the precipitated particulates is not considered. Only an immobile solid phase is considered, but the microstructure of the layer is not studied.

The effect of the flow rate on the wax deposition is hitherto unresolved. Creek et al. (1999) experimentally found that when the flow rate is increased, the deposition rate decreases, rather than increases as claimed by others (Hamouda and Davidson, 1995). The deposition rate, as well as the wax content, is found to experience significant changes when the flow is transitioned from laminar to turbulent (Hamouda and Davidson 1995; Creek et al. 1999). These results remain largely unexplained from a fundamental point of view.

In all of the previous modeling efforts, the immobile gel layer adjacent to the cold pipe wall is modeled as a porous medium and its effect on the macro-scale flow in the bulk liquid is modeled by adding a Darcy-like term −(μ/κ)v in the pressure gradient in the Navier-Stokes equation (where μ is the fluid viscosity, κ is the effective permeability, and v is fluid velocity):

$$\frac{\partial ( ρ v )}{\partial t} + ∇ \cdot ( ρ vv ) = - ∇ p - \frac{μ v}{κ} + ρ g + ∇ \cdot ( 2 μ D ) \qquad Eq . ( 1 )$$

Here D is the rate-of-strain tensor. The Carman-Kosney equation is routinely used to relate the permeability κ to the porosity (liquid fraction) ε:

$$κ = \frac{1}{c} \frac{{ɛ}^{2}}{{( 1 - ɛ )}^{2}} \qquad Eq . ( 2 )$$

The morphology coefficient C depends on the morphology/microstructure of the porous medium (gel layer), but a value of C=10⁶/m² has been used without justification in the literature (Banki et al. 2008; Hoteit et al. 2008). Thus, the effect of the morphological change or microstructure evolution of the gel layer on the macro-scale flow has not been addressed.

Current technology is limited to one dimensional analysis of deposition processes, neglecting the interplay of fluid flow structures with the deposition process. The resulting models are generally not predictive and require extensive tuning with experimental data. It is apparent that there is still considerable uncertainty on the wax deposition mechanisms in a pipeline. Radial molecular and thermal diffusion has been the focus of past efforts. Effects of axial diffusion, which is important at the latter stage of the growth, flow rate, particulate dispersion, microstructure growth, and turbulent flow, have not fully been explored. Interaction between the microstructure of the gel layer and the macro-scale flow has not been studied. A fundamental understanding of the mechanisms of wax deposition and aging (hardening) is essential for the optimal design and implementation of various wax removal techniques.

### SUMMARY

The methodologies described herein enable detailed predictive modeling of the processes leading to the deposition on the pipeline walls and resulting flow blockage. The proposed methods can be applied to any flow blockage problem that results from deposition of initially small scale particles that may grow due to agglomeration or phase transition, for example plaque deposition in blood vessels.

Modeling wax formation and deposition in the presence of strong flow, heat and mass transfer in a pipeline poses a significant challenge due to the complicated couplings among various physical effects occurring at diverse length scales. There is still considerable uncertainty on the wax deposition mechanisms in a pipeline. A method for modeling wax deposition phenomenon in a pipeline employing multi-scale numerical simulations is described herein. In some embodiments, the multi-scale coupling method for formation and aging process of a deposit involves a phase change on a level set-tracked solid/liquid interface and motion and growth of solid particles suspended in fluid flow. The method may comprise increasing precipitation rate to force a time scale of the phase change process to match that of a bulk flow. The simulations can couple the microstructure evolution in the gel layer at the micro and the meso scales with the flow of the bulk liquid at the macro-scale. In some embodiments, particle evolution at the micro- and meso-scales includes the interactions of particle-particle, particle-wall, particle-interface.

Quantitative analysis of the microstructure evolution of the growing gel layer has never been available before. The simulations may include modeling the growing microstructure from wax precipitation particulates in the presence of flow and heat transfer. In some embodiments, the method comprises using a scalable, parallel-coupling Lagrangian description to capture submicro-micro scale particles using particle-particle, particle-wall, and particle-interface collision models to describe interaction between Lagrangian particles, particle-wall, and particle-level set tracked interface using a transfer algorithm to migrate the particle. In some aspects, once particles have reached a threshold size, they are transferred into an interface-capturing Eulerian description that resolves the resulting complex interface morphology and its interaction with the fluid flow. The precipitation may be attributed to the temperature gradient in the fluid, and may initiate molecular diffusion, thereby ensuring the continued precipitation, in some aspects. In some embodiments, the precipitation is simulated in the presence of heat transfer, and may provide information on wax content, wax aging. In some embodiments, the multi-scale method reflects physical phenomena occurring at multiple time scales in wax deposition.

In some embodiments, a morphology-dependent permeability parameter, C, in a Carman-Kosney equation is computed and evolved in time from the meso-scale simulation. The growth of solid particles simulates the growing microstructure of wax precipitation particulates or asphaltene particulates, in some aspects.

Modeling of the microstructure evolution provides accurate information on the wax content and thus the aging process of the wax. This multi-scale approach realistically reflects the physical phenomena occurring at diverse length scales in wax deposition, as well as other multiphase multi-component precipitation and solidification problems. Examination and analysis of the morphology of the gel layer using a Cross-Polarizing Microscope (CPM) and wax composition using a Differential Scanning calorimeter (DSC) may be employed to validate the simulations and methods disclosed herein.

The predicted wax layer content and growing profiles as well as scaling laws may be applied to field applications. The multi-scale, multi-physics coupling approach represents a transformative step in the understanding of multi-phase, multi-component phase change phenomena in the presence of strong flow and heat and mass transfer.

In certain embodiments, the simulations may predict wax formation and deposition phenomenon in a pipeline by combining multi-scale numerical simulations with observed experimental results. For example, the microstructure evolution in the gel layer at the meso-scale may be combined with the pressure driven flow in the bulk liquid at the macro-scale. The microstructure evolution of the gel layer provides accurate information on the wax content, and thus the aging process of the wax. In some embodiments, the aging process is simulated by computing the growing microstructure from wax precipitation particulates in the presence of flow and heat transfer. The microstructure may be used to compute the permeability of the gel layer by volume averaging. In some embodiments, the permeability is fed into the Darcy-like pressure drop term in the modified Navier-Stokes equation at the macro-scale for the pipe flow. The updated macro-scale velocity and temperature at the macro-scale interface between the gel layer and the liquid region may be used to evolve the gel layer microstructure. This multi-scale approach realistically reflects the physical phenomena occurring at diverse length scales in wax deposition, as well as other multiphase multi-component precipitation and solidification problems. The morphology-dependent permeability parameter, C, in the Carman-Kosney equation has previously been held as a constant a priori without justification. However, in some embodiments presented herein, the morphology-dependent permeability parameter is computed and evolved in time from the meso-scale simulation.

In one application of the simulations, wax deposition in a pipeline may be simulated. As stated above, issues such as shear dispersion of wax crystals, flow rate effects, independent mass and thermal flux, have remained controversial in wax deposition studies. Separate mechanisms may be characterized in terms of dimensionless parameters, in ranges relevant to wax deposition, which has not been attempted before. The modeling allows wax precipitation on the pipe inner wall and in the bulk of the fluid wherever the temperature drops below WAT. The precipitated crystallites near the pipe wall and those in the bulk of the fluid are allowed to be transported by the motion of the fluid. Whether these crystallites will be deposited onto the wall is determined by sticking/rebounding models. The growth of the gel layer adjacent to the pipe wall, and the growth and dispersion of the wax particulates in the bulk are followed in the simulations.

Wax layer growth profiles may be simulated in space and time, and express the growth in terms of dimensionless groups. Some embodiments allow for the extraction of scaling laws, which allow up-scaling laboratory loop experiments to field applications. Observed experimental results may be used to verify and validate the computed wax layer profiles.

Wax deposition mechanisms may also be determined in dimensionless space. For example, the relative importance of each deposition mechanism, in terms of dimensionless groups, may be characterized. Wax growth pattern modelling may be controlled and/or altered. The predicted wax layer growing profiles and scaling laws may be applied to real-world, field applications. The multi-scale, multi-physics coupling approach represents a transformative step in the understanding of general multi-phase, multicomponent phase change phenomena in the presence of strong flow and heat and mass transfer.

In some embodiments, a Lagrangian description may be used to model the motion and growth of a large amount of small scale solid kernels/particles suspended in the fluid flow. The simulation may include transfer of these particles, once they have reached a threshold size through either precipitation growth or agglomeration into an interface capturing Eulerian description that resolves the resulting complex interface morphology and its interaction with the fluid flow. In some embodiments, this results in a multi-scale coupling procedure that enables predictive modeling of the deposition processes in fluid flows. The multiscale Lagrangian/Eulerian model enables detailed predictive simulations of deposition processes of precipitated solids, like wax crystals or asphaltenes, on boundaries like walls exposed to fluid flow, in some aspects. In certain embodiments, a scalable, parallel coupling procedure of Lagrangian description may be used for small scale particle modeling to Eulerian description for modeling the complex interface geometry results from particle deposition, agglomeration, and precipitation. The multiscale coupling method may enable detailed predictive simulations of particulate deposition.

### BRIEF DESCRIPTION OF THE DRAWINGS

The following drawings illustrate by way of example and not limitation. For the sake of brevity and clarity, every feature of a given structure may not be labeled in every figure in which that structure appears.

FIG. 1 is a photograph of a cross-sectional slice of a pipeline plugged with wax deposit according to one embodiment of the disclosure.

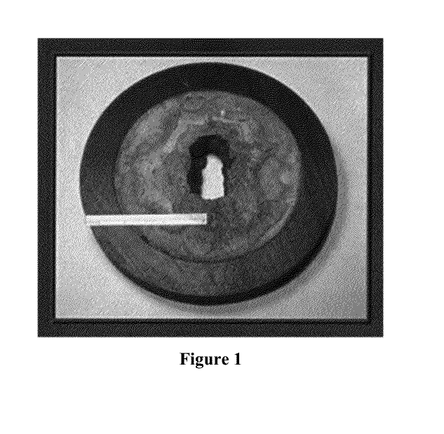

FIG. 2 is a diagram illustrating the multi-scale character of the wax deposition process according to one embodiment of the disclosure.

FIG. 3 is a diagram illustrating the macro-scale computational domain with multiple constituent meso-scale domains according to one embodiment of the disclosure.

FIG. 4 is a diagram illustrating the meso-scale computational domain according to one embodiment of the disclosure.

FIG. 5 is a diagram of the level set tracked phase boundary on a micro-scale grid assembled using the RLSG approach according to one embodiment of the disclosure.

FIG. 6 is a vector field plot of Stokes flow pattern in the flow solver after Lagrangian particle transfer according to one embodiment of the disclosure, with relative velocity is in the top-right direction.

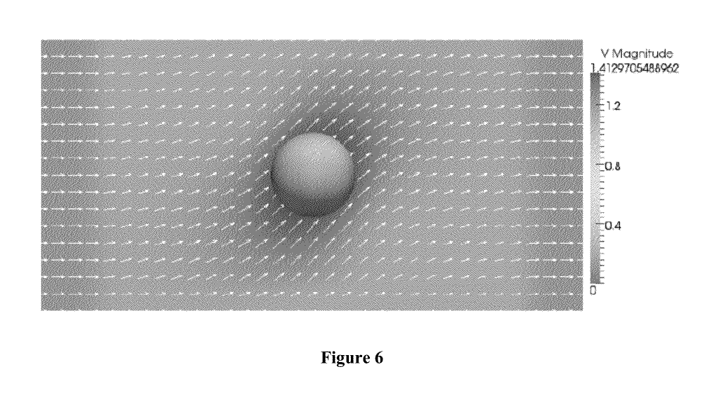

FIGS. 7A and 7B are velocity magnitude maps of level set captured wax particle with settling velocity before touching the bottom wax layer (FIG. 7A) and after merging with the bottom wax layer (FIG. 7B) according to one embodiment of the disclosure.

FIG. 8 is a Resolved Porous Structure with particles setup initially with equal size according to one embodiment of the disclosure.

FIG. 9 is Resolved Porous Structure with particles setup initially with variable size according to one embodiment of the disclosure.

FIG. 10 is a schematic block diagram illustrating one embodiment of a computer system that may be used in accordance with certain embodiments of the system for simulating wax deposition according to one embodiment of the disclosure.

FIG. 11 is a schematic flowchart diagram illustrating one embodiment of a method for simulating wax deposition according to one embodiment of the disclosure.

FIG. 12 is a schematic flowchart diagram illustrating one embodiment of a multiscale simulation.

FIG. 13 is a schematic that illustrates the coupling relationship between macro-, meso-, and micro-scale simulations according to one embodiment of the disclosure.

FIGS. 14A and 14B are illustrations of particle-shapes. FIG. 14A is a dumbbell shape whose ratio of surface area to volume is larger than that of a corresponding spherical particle of equal volume. FIG. 14B is a prolate-spheroid composite particle C, which is used to set the initial level set scalar due to particle transfer.

### DETAILED DESCRIPTION

Various features and advantageous details are explained more fully with reference to the non-limiting embodiments that are illustrated in the accompanying drawings and detailed in the following description. It should be understood, however, that the detailed description and the specific examples, while indicating embodiments of the invention, are given by way of illustration only, and not by way of limitation. Various substitutions, modifications, additions, and/or rearrangements will become apparent to those of ordinary skill in the art from this disclosure.

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The process of wax deposition is controlled by the conservation laws for mass, momentum, species mass fractions, and energy as well as thermodynamic relations. For an incompressible liquid these are:

$$\begin{matrix}∇ \cdot v = 0 & Eq . ( 3 ) \\ \frac{\partial ( ρ v )}{\partial t} + ∇ \cdot ( ρ vv ) = - ∇ p + ∇ \cdot ( 2 μ D ) & Eq . ( 4 ) \\ \frac{\partial }{\partial t} ( {\sum }_{i}^{N} {c}_{i} {h}_{i} ) + ∇ \cdot ( {\sum }_{i}^{N} {c}_{i} {h}_{i} v ) = ∇ \cdot ( {κ}_{eff} ∇ T ) & Eq . ( 5 ) \\ \frac{\partial {c}_{i}}{\partial t} + ∇ \cdot ( {c}_{i} v ) = ∇ \cdot ( {D}_{i}^{M} {∇}_{{c}_{i}} + {D}_{i}^{T} ∇ T ) - {s}_{i} ( {c}_{i} - {s}_{i}^{sol} ) & Eq . ( 6 )\end{matrix}$$

where ρ is the density, v is the velocity of the liquid, cᵢ, hᵢ are the volume of the fraction and specific enthalpy of component i in the liquid, D is the rate-of-strain tensor, Dᵢ^{M}, Dᵢ^{T} are the mass molecular and thermal diffusion coefficients for species i, cᵢ^{sol} is the solubility limit of species i at the local temperature, and sᵢ is the rate at which species i precipitates out of the liquid, which is proportional to the local concentration cᵢ. Although a waxy crude oil is chemically very complex, the rate-of-strain tensor can be modeled assuming a Newtonian fluid above the WAT.

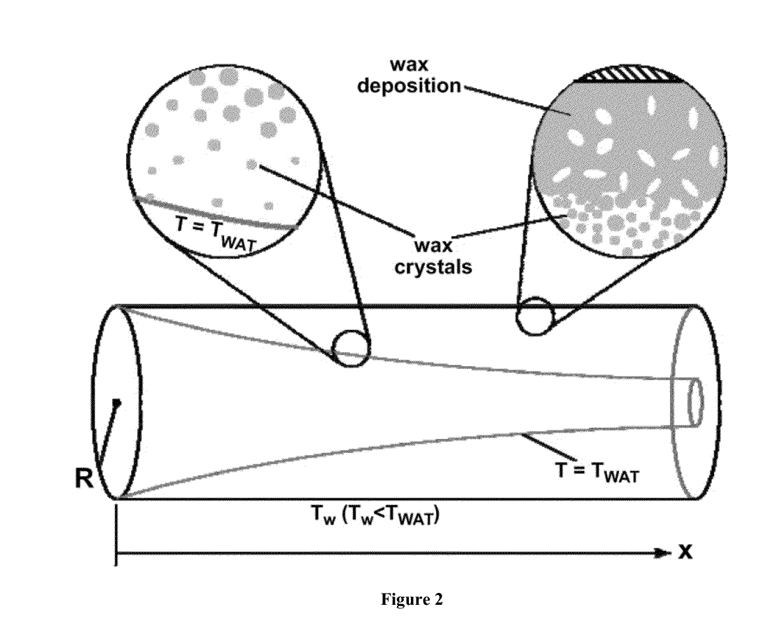

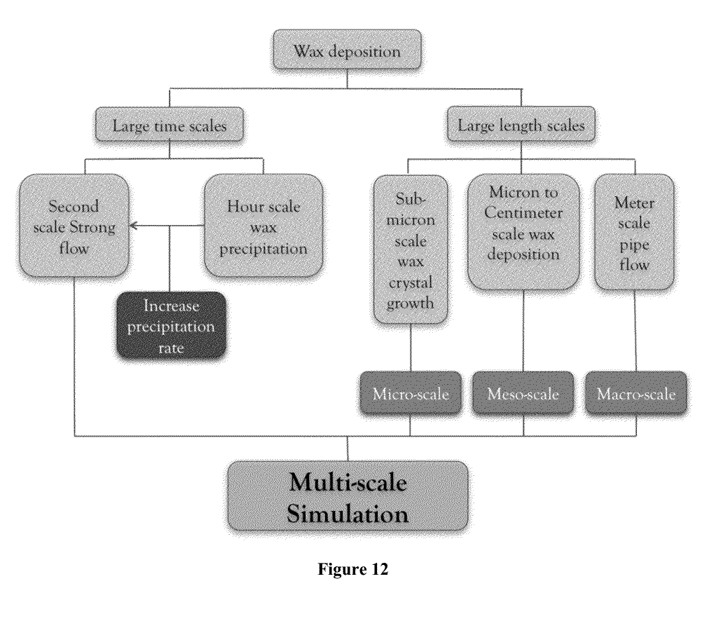

Even though the liquid flow during wax formation and deposition is, in principle, fully described by equations (3)-(6), the equations are subject to complex boundary conditions. These not only include the pipe flow inlet, outlet, and walls, but also the time evolving boundary between solid wax crystallites and the liquid oil. Furthermore, to use equations (3)-(6) directly, all time and length scales inherent in the wax formation and deposition process need to be resolved. Unfortunately, the length scales range from the sub-micron scale during wax crystal growth, from the micron scale to centimeter scale during wax deposition, and up to the meter scale of the pipe geometry, see FIG. 2. The wax precipitation process is slow compared to the crude oil flow in the pipe. It may take days for the wax deposit to achieve a thickness of several millimeters. The Reynolds number for the crude oil flow may be greater than 100, and may become turbulent. The time scale for the oil flow is on the level of seconds. It is thus computationally impossible now and in the foreseeable future to resolve all scales. Instead, some level of modeling has to be introduced. A novel, multi-scale strategy is proposed to achieve a consistent model that takes the physical processes on the different scales directly into account. To resolve such large range of time scale, wax precipitation rate is enlarged by a user-defined factor to accelerate the condensation process. The three different modeling scales are: a macro-scale, a meso-scale, and a micro-scale, see FIG. 12.

At the macro-scale, the gel layer adjacent to the pipe wall comprising both a suspension of wax crystallites and deposition at the pipe's inner walls is modeled as a porous medium and the bulk crude oil is treated as a single-phase multi-component liquid. Since the high molecular weight components have a relatively small volume fraction in the bulk, the viscosity and thermal conductivity in the bulk μ, κ can be approximated as constants and the fluid is essentially a simple Newtonian fluid. On the macro-scale, the gel as a porous medium and its effect on the liquid flow is modeled by adding the Darcy-like term −(μ/κ)v to the pressure gradient in the Navier-Stokes equation:

$$\frac{\partial ( ρ v )}{\partial t} + ∇ \cdot ( ρ vv ) = - ∇ p - \frac{μ v}{κ} + ρ g + ∇ \cdot ( 2 μ D ) \qquad Eq . ( 7 )$$

The Carman-Kosney equation is used to relate the permeability κ to the porosity (liquid fraction) ε:

$$K = \frac{1}{C} \frac{{ɛ}^{3}}{{( 1 - ɛ )}^{2}} \qquad Eq . ( 8 )$$

Here, the liquid fraction ε=ε(x,y,z,t) changes with location in the gel layer due to the gel micro-structure, and with time t due to the aging of the gel layer. The morphology coefficient C depends on the evolving morphology of the gel layer, C=C(x,y,z,t). Both the liquid fraction in the gel layer ε(x,y,z,t) and the morphology coefficient C(x,y,z,t) are obtained from a meso-scale modeling of the gel layer evolution. The effective thermal conductivity k_{eff}=k_{eff}(ε,c₁,c₂, . . . c_{N}) needed in the enthalpy equation can be obtained by recurring use of the Maxwell effective conductivity formula for binary mixtures, and k_{eff} approaches the value of the liquid thermal conductivity k as one moves out of the gel layer.

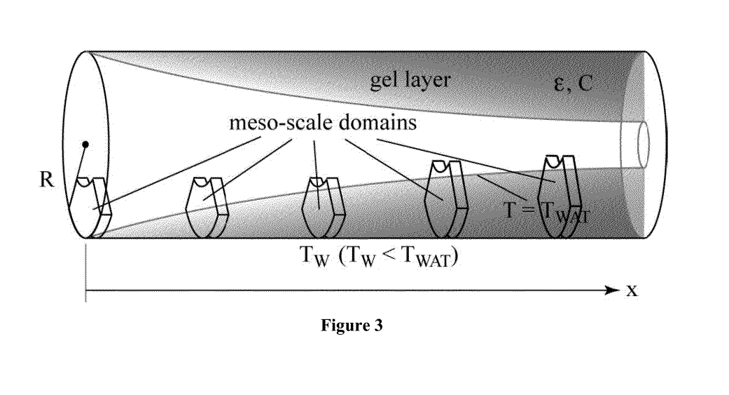

FIG. 3 shows the macro-scale computational domain, stretching from the pipe inlet to the pipe outlet, and the developing gel layer, modeled on the macro-scale by the liquid volume fraction ε and the morphology coefficient C. In order to obtain space and time dependent values of ε and C, mesoscale simulation domains are anchored along the macroscale pipe domain against the inner wall. Values for ε and C are then calculated from the meso-scale solutions. Although the gravitational force can usually be neglected in typical applications, indicating that the flow and wax deposition is axisymmetric, all three dimensions may be simulated in the macro-scale. Incorporation of gravitational force enables the identification of any azimuthal instability modes that might be present in the wax formation process that have been neglected in the past. This enables the current method to account for laminar-to-turbulence transitions possibly occurring due to the contraction of the available unblocked diameter, in some embodiments.

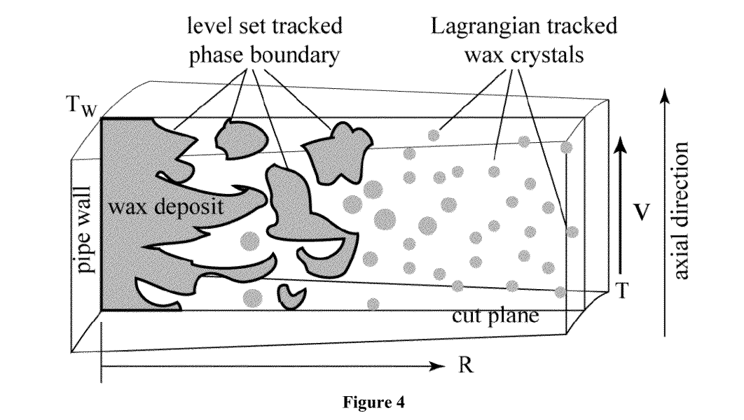

In order to resolve most details of the wax crystallization and deposition processes at the meso-scale, the spatial growth of the gel layer is described by a temporal simulation in an axial-direction periodic computational domain (FIGS. 3-4). Many meso-scale channel domains are anchored against the inner wall in the flow direction along the macro-scale pipe domain.

To capture the crystallization and wax deposition process, a hybrid Lagrangian/Eulerian strategy may be applied. The meso-scale computational domain may be seeded by a large number of sub-micron Lagrangian particles representing potential crystallization sites. For each of these particles, ODEs are solved for their radius, temperature, and spatial position similar to multi-component spray particles in atomization simulations, with the only difference being that the particle radius ODE does not describe evaporation, but rather condensation and crystalline growth. Once an individual particle has reached a threshold size, either through crystalline growth or collision merging with adjacent particles, it may be removed from the Lagrangian representation and its liquid/solid phase interface may be tracked by a level set method instead.

### Scale-Coupling Procedure

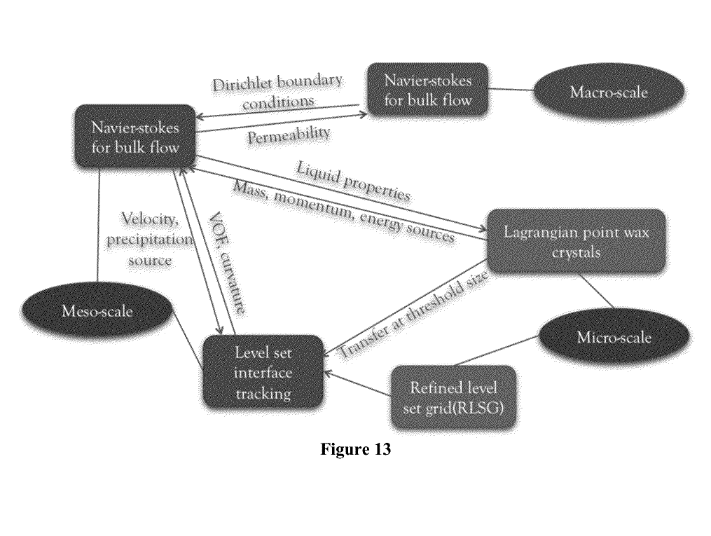

In order to ensure the multi-scale simulation models are computationally feasible and obtain consistent numerical results, appropriate coupling procedures between different scale levels need to be defined. FIG. 13 shows the coupling relationship between different scales.

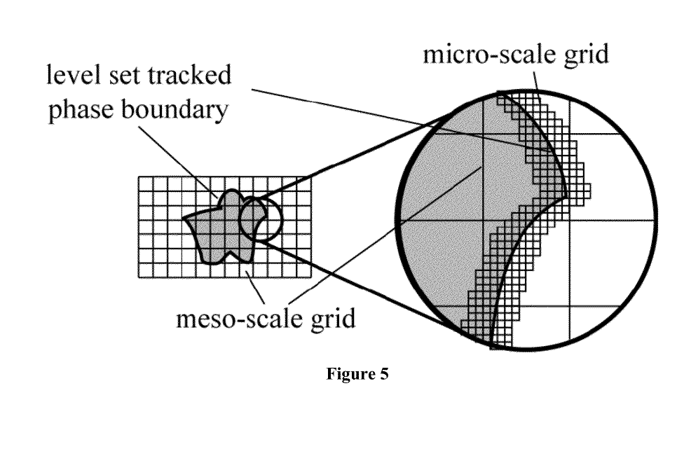

At the micro-scale, the wax crystals generated by wax crystallization are represented by a Lagrangian point particle approach. The coupling procedure from micro-scale Lagrangian particles and inserted into a level set tracked interface is described as follows. When an individual Lagrangian wax crystal grows by wax crystallization or collision merging with other Lagrangian particles to a threshold size that is in the order of the meso-scale grid spacing, it is removed from the Lagrangian representation to a level set tracked interface description. In the refined level set grid (RLSG) method, a refined grid is defined only in a narrow band surrounding the phase interface and is dynamically generated and updated to move with the time-evolving interface geometry (see FIG. 5). If the particle is not large enough to be injected as an separate solid structure and it collides with the level set interface, it is absorbed into the level set tracked interface as a source term. It is worth to note that for the first time, the two types of mechanisms leading to wax deposition, the molecular diffusion and wax particulate deposition, are resolved respectively.

A full two-way coupling model (Moin and Apte, 2006; Apte, 2008) is applied between the micro-scale Lagrangian representation and the meso-scale fluid flow. The Lagrangian particle approach by itself solves ODEs for each individual particle using fluid information such as viscosity, velocity and density to update the radius, position, energy and temperature of the wax crystals. In the opposite coupling direction, the effect of particles on the meso-scale fluid is represented by adding source terms of mass species, momentum and energy to the governing equations of the fluid flow. The level set method at the micro-scale refined grid level uses an iso-scalar G=0 to represent a sharp boundary interface between the liquid oil and the solid wax phase. In order to capture the effect of the interface on the meso-scale fluid flow in a finite volume scheme, a single fluid approach is applied in the meso-scale flow solver with the properties, such as density, viscosity, and thermal conductivity, at the interface switched from oil to wax. This approach has been employed successfully in the liquid/gas system for atomization simulations (Herrmann, 2008). The meso-scale fluid velocities are interpolated to the micro-scale refined grid to achieve the coupling from meso-scale to micro-scale. Meanwhile, the coupling from micro-scale to meso-scale is achieved by integrating the micro-scale solution over the meso-scale grid.

The coupling from the macro-scale to the meso-scale is achieved by using the numerical solution from macro-scale as Dirichlet boundary conditions in the meso-scale simulation. As mentioned above, the coupling from meso-scale to macro-scale is accomplished by calculating porosity ε and morphology coefficient C from the meso-scale level set tracked interface structure of the porous medium and wax crystal distribution to estimate the Darcy-like term in the momentum equation. Both porosity and morphology coefficient are updated at every time step and variant with time and space. This is different from the constant morphology and porosity assumption in previous studies. Since the meso-scale domain is a small slice of the macro-scale domain adjacent to the channel wall, it is necessary to seed several meso-scale domains throughout the macro-scale domain to have consistent, reasonable spatial distribution of meso-scale information.

### Governing Equations

The liquid flow on the meso-scale in the gel layer can be described by solving the governing equations (9)-(13) augmented by source and sink terms in the momentum, enthalpy, and species concentration equations describing mass, Sᵢ, momentum, F_{d}, and heat exchange, Hₛ, with the Lagrangian tracked crystal particles and the level set equation tracking the evolution of the crystallization front. Assuming petroleum is an incompressible fluid, the Navier-Stokes equations offer a good mathematical model to describe unsteady incompressible fluid flow on the meso-scale,

$$\frac{\partial ( ρ v )}{\partial t} + ∇ \cdot ( ρ vv ) = - ∇ p + ∇ \cdot ( 2 μ D ) + {F}_{d} . \qquad Eq . ( 9 )$$

Due to the incompressibility assumption, the continuity equation leads to a divergence free constraint,

∇·v=0. Eq. (10)

The temperature distribution in the pipe determines the location where wax crystallization can take place. The temperature field when simulating the wax deposition process may be resolved by solving the energy equation in addition to the equation for the concentration cᵢ of wax species dissolved in the petroleum,

$$\begin{matrix}\frac{\partial }{\partial t} ( {\sum }_{i}^{N} {c}_{i} {h}_{i} ) + ∇ \cdot ( {\sum }_{i}^{N} {c}_{i} {h}_{i} v ) = ∇ \cdot ( κ ∇ T ) + {H}_{s} & Eq . ( 11 ) \\ \frac{\partial {c}_{i}}{\partial t} + ∇ \cdot ( {c}_{i} v ) = ∇ \cdot ( {D}_{i}^{T} ∇ T ) + {S}_{i} & Eq . ( 12 )\end{matrix}$$

In the governing equations above, F_{d}, Hₛ and Sᵢ are momentum, energy and mass source or sink terms, respectively. These source terms comprise two parts: one part is generated by coupling the micro-scale Lagrangian particles to the meso-scale flow solver; the other part is generated due to the precipitation process occurred on the level set interface.

To describe the geometry of the solid wax/petroleum phase interface in the gel layer, a level set approach may be used. The level set scalar G satisfies the equation

$$\frac{\partial G}{\partial t} + v \cdot ∇ G = 0. \qquad Eq . ( 13 )$$

This equation may be solved using the RLSG approach, with the velocity calculated by simple tri-linear interpolation from the flow solver solution mesh.

### Flow Solver and RLSG Method

In the simulations, the Navier Stokes equations and the mass and energy transport equations may be solved using a second order fully-conservative scheme on a staggered structured mesh in space and a second order semi-implicit Crank-Nicolson method for time advancement. Details concerning the numerical method can be found in Desjardins et al. The Refined Level Set Grid method uses a fifth order WENO scheme combined with third order Runge-Kutta TVD time advancement to solve the distance function level set scalar equation. The flow solver and the level set solver may be solved staggered in time, thereby maintaining overall second-order accuracy in time.

### Lagrangian Particle Transfer

The dissolved wax in the oil will crystallize when the temperature is lower than the WAT and condense on the surface of the paraffin wax particles existing in the oil flow. Thus, the solid crystals will grow and increase in size. When a particle is large enough, the phase discontinuity of the wax crystal and the oil around it may have a size effect on the flow that is not negligible. A Lagrangian point particle model for the wax crystal may then no longer be an appropriate description. Instead, the actual phase interface geometry may be taken into account. Here, a level set interface capturing approach based on the RLSG method may be employed, since this can track the evolution of the wax crystallization front and its impact on the flow field. In addition, the RLSG approach may provide enough fidelity to capture the meso-scale geometry of the porous gel layer. Based on the considerations above, a switch may be made from the numerical description for large solid wax particles from a Lagrangian point particle model to the RLSG interface capturing approach. The transfer is the opposite of the drop transfer algorithms developed for primary atomization simulations.

### Transfer Criterium

The criterium used to determine whether to initiate the Lagrangian particle transfer may be based purely on wax crystal volume,

V_{d}=V_{threshold} Eq. (14)

where V_{d} is the Lagrangian particle volume and V_{threshold} is a threshold volume chosen to be the flow solver grid volume, since the typical prerequisite to apply Lagrangian point particle models is that the particle size is smaller than the flow solver grid size. Note that since the RLSG approach is based on a refined mesh independent from the flow solver grid, it is possible to actually resolve the sub-flow solver sized solid structure.

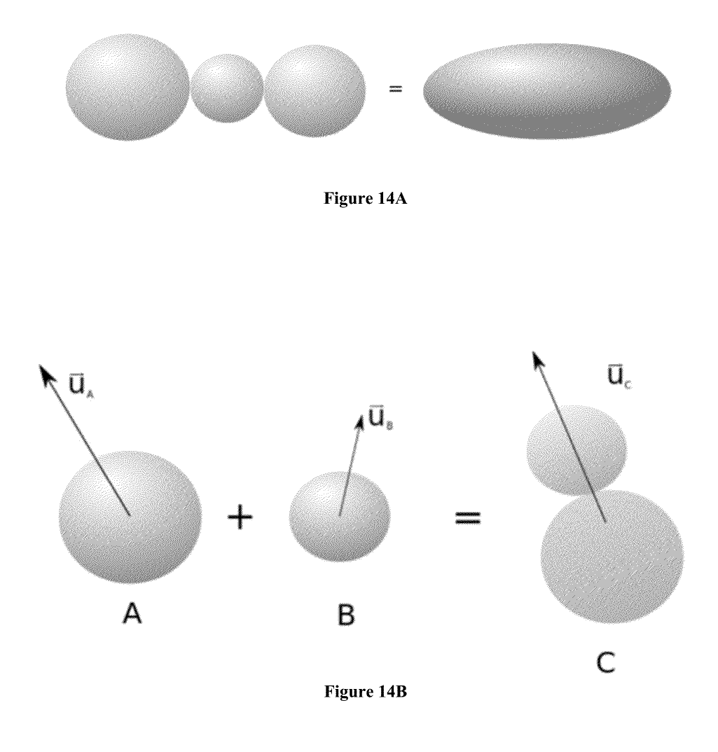

The initial level set scalar due to particle transfer is set by assuming the particle has the shape of prolate-spheroid (see FIG. 14B), the two radii of the particle are calculated based on the known volume and surface area.

### Stokes Flow

The Lagrangian particle transfer can cause a velocity discontinuity at the particle position in the flow, which could result in an instability in the flow solver and a rapid deformation of the wax crystal interface after transfer. To address this issue, a consistent velocity field in the oil surrounding the transferred wax particle may be identified directly after transfer. In pipeline flows, the relative velocity between the floating solid wax crystal and the oil is small. The length scale, i.e., the particle diameter, at threshold condition, may also be small. Consider the example where the relative velocity magnitude is uᵣₑₗₐₜᵢᵥₑ=1.0e-2 m/s, the particle diameter is d_{d}=1.25e-4 m, and the oil density and dynamic viscosity is p=828.5 kg/m³ and μ=8.7e-3 Pa·s, respectively. Then, the resulting Reynold number Re≈0.1 satisfies the condition Re<<1 for creeping flow (Stokes flow). Therefore, it is possible to set the velocity based on Stokes flow at the position where a particle is transferred without a significant adverse effect to the flow itself.

Since Stokes flow around a sphere is axisymmetric along the axis in the relative flow direction, a stream-function in spherical coordinates r, θ, φ is used, Ψ=Ψ(r,θ), resulting in

$${∇}^{4} Ψ = {[ \frac{\partial }{\partial {r}^{2}} + \frac{sin ( θ )}{{r}^{2}} \frac{\partial }{\partial θ} ( \frac{1}{sin ( θ )} \frac{\partial }{\partial θ} ) ]}^{2} Ψ = 0. \qquad Eq . ( 15 )$$

The velocity components related to the stream function are

$$\begin{matrix}{v}_{r} = \frac{1}{{r}^{2} sin θ} \frac{\partial Ψ}{\partial θ} & Eq . ( 16 ) \\ {v}_{θ} = \frac{1}{r sin θ} \frac{\partial Ψ}{\partial r} & Eq . ( 17 )\end{matrix}$$

No-slip boundary conditions are applied on the particle surface

$$\begin{matrix}Ψ ( r = R ) = 0 & Eq . ( 18 ) \\ {\frac{\partial Ψ}{\partial r} \vert}_{r = R} = 0 & Eq . ( 19 )\end{matrix}$$

The streaming velocity at infinite distance from the particle (r→∞) is

vᵣ˜−|uᵣₑₗₐₜᵢᵥₑ|cos θ Eq. (20)

v_{θ}˜|uᵣₑₗₐₜᵢᵥₑ|sin θ Eq. (21)

The Stokes flow solution is given by as

$$\begin{matrix}{v}_{r} \sim - \vert {u}_{relative} \vert cos θ [ - \frac{1}{2} {( \frac{r}{R} )}^{- 3} + \frac{3}{2} {( \frac{r}{R} )}^{- 1} - 1 ] & Eq . ( 22 ) \\ {v}_{θ} \sim \vert {u}_{relative} \vert sin θ [ - \frac{1}{4} {( \frac{r}{R} )}^{- 3} + \frac{3}{4} {( \frac{r}{R} )}^{- 1} + 1 ] & Eq . ( 23 )\end{matrix}$$

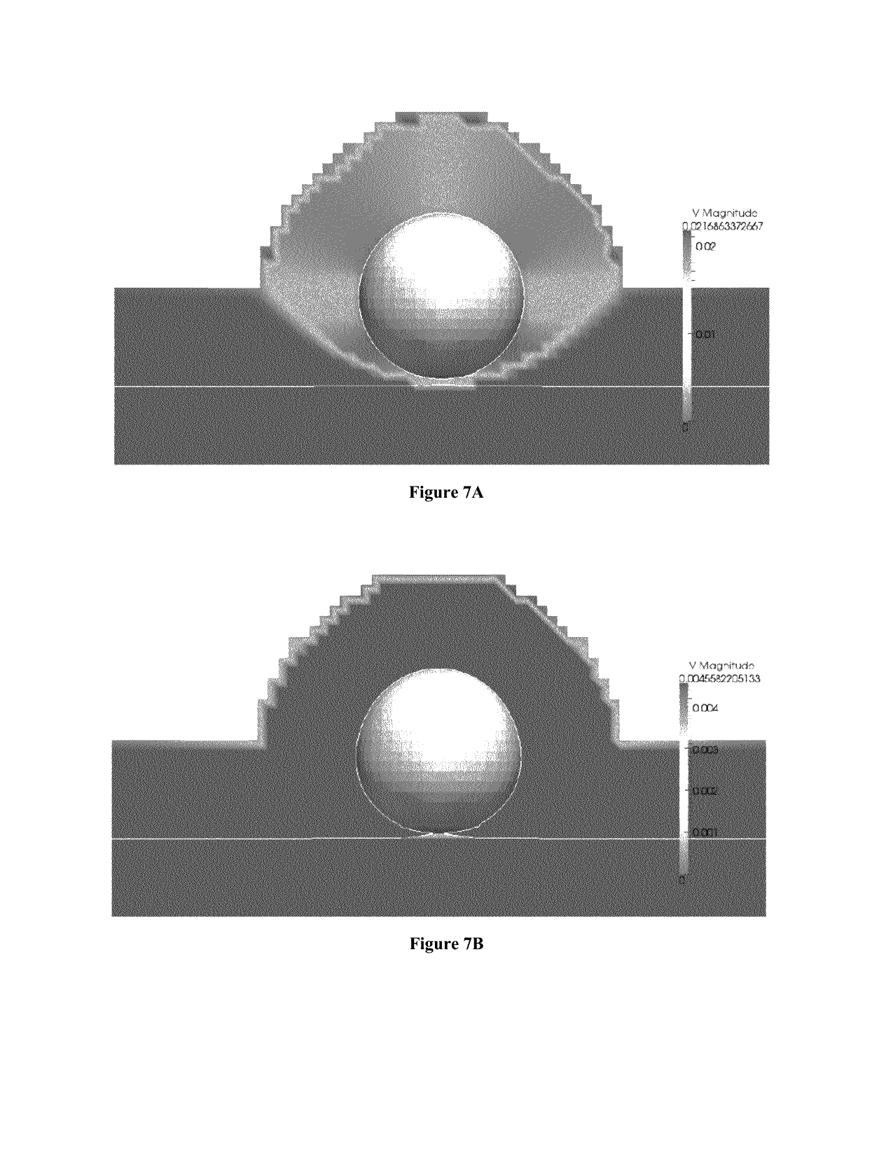

This solution may be used to reset the flow solver velocity field only up to one particle diameter away from the particle center. In this case, the finite volume effect is taken into account. However, the original velocity magnitude on each flow solver grid may be much larger than the Stokes flow velocity, if uᵣₑₗₐₜᵢᵥₑ is calculated as the difference between the oil flow velocity at the particle center and the Lagrangian point particle velocity. Instead of using the flow velocity at the particle's center determined from interpolation of the surrounding flow solver grid points, an arithmetic average of the pre-transfer oil flow velocity in the region where the Stokes flow may be applied is used to determine uᵣₑₗₐₜᵢᵥₑ. Thus, a consistent smooth velocity distribution may be constructed around the particle on the flow solver grid, which may minimize artificial deformations of the transferred particles in the level set description. FIG. 7 shows the Stokes flow pattern around a particle just after transfer. The relative velocity is in the top-right direction.

Standard particle-particle, particle-wall collisions are applied to describe the interactions between the Lagrangian wax crystals as well as with solid wall. When two particles collide, they are assumed to stick to each other and form a dumbbell shape particle, see FIG. 14A. The assumed shape of the resulting particle leads to a larger surface area/volume ratio relative to a sphere with the same volume, resulting in a relatively larger precipitation rate on the particle surface. Another assumption is made that the collision particles connect in the direction of the relative flow velocity between the particle and the bulk fluid. Both assumptions ensure the resulting particle has smaller drag force than a spherical particle with the same volume. When the particle collides with the level set interface, this particle will be treated as a mass source to the closest interface grid point. At this point, the equation becomes

$$\frac{\partial G}{\partial t} + v \cdot ∇ G = {v}_{n} \vert ∇ G \vert \qquad Eq . ( 24 )$$

where the corresponding normal velocity magnitude vₙ is determined by the particle volume Vₚ and the cross sectional area A_{c} of the particle:

$${A}_{c} = \frac{1}{4} {π ( \frac{6 {V}_{p}}{π} )}^{\frac{2}{3}} \qquad Eq . ( 25 )$$

Zero-Velocity Extension from the Gel Layer

To build up a porous structure, initially, a planar interface may be set up, which represents a very thin solid wax layer that resides at the bottom wall of a channel configuration. As time increases, more and more large particles may be moved from a Lagrangian point particle representation to a level set description. These level set solid particles may continue to move in the flow. However, as soon as any part of these level set wax particles comes into contact with the bottom plane wax interface, the particle is assumed to join the wax layer and form an immovable solid structure. The transport velocity for all the then joined interface segments in Eq. 13 becomes zero. The remaining issue after a continuous interface is identified is to ensure that the transport velocity in Eq. 13 is set to zero, not only at the phase interface, but also in the entire band structure of the RLSG method associated with the joined bottom wax layer. This may be achieved by using a parallel Fast Marching Method, extending the zero transport velocity defined at the bottom wax layer interface normal into its narrow band.

As an example, FIGS. 7A-7B show a level set captured wax particle approaching the bottom wax layer (thin white line). As long as the particle does not touch the wax layer, the velocity in the narrow band surrounding the moving particle is the solution of the Navier-Stokes equation obtained by the flow solver (FIG. 7A). However, as soon as the particle touches the bottom wax layer, particle and wax layer merge and will henceforth be treated as a solid. To suppress any deformation of the resulting structure, the transport velocity in the narrow band surrounding the joined structure is set to zero (FIG. 7B).

### Model for Phase Change Process on the Solid/Liquid Interface in the Level Set Domain

The immobile deposit structure against the inner wall ages due to the particulate deposition and the condensation process. This section describes the method employed to model the phase change occurred on the solid/liquid interface in the level set domain. The mass condensation rate in one flow solver grid cell, where there is solid/liquid interface is

dmdt=∂{0<VOFᵢ<1 or (VOFᵢ=1 & VOFₙᵢ=0)}s(cᵢ−cᵢ^{sol})ΔV_{c} Eq. (26)

where VOFᵢ is the volume fraction of solid component i and VOFₙᵢ is the volume fraction of component i in any neighbor cell. s(ci−cᵢ^{sol}) is the source term due to phase change on the solid/liquid interface. ΔV_{c} is the volume of the flow solver grid cell. The corresponding propagating normal velocity of the interface is

$${v}_{n} = \frac{dmdt}{{ρ}_{i} A} ∇ G \qquad Eq . ( 27 )$$

where ρᵢ is the density of solid component i, A is the surface area of the solid/liquid interface on one flow solver grid cell, and ∇G is the interface norm. An iterative method is applied to capture the growth of interface due to a phase change. The following algorithm describes the detailed procedure. The corresponding source terms will be augmented to the mass, momentum and energy equation.

### Resolve the Complex Boundary Condition in the Flow Solver

In the mesoscale simulation, when solving the Navier-Stokes equations for bulk oil flow, the porous deposit structure formed in the level set capturing domain acts as a complex boundary condition. To resolve this complex boundary, the Immersed Boundary (IB) method is applied. A source term is augmented to the Navier-Stokes equations as follows.

$$f = α \cdot {VOF}_{s} \cdot \frac{{ρ}_{o} {u}_{0} - {ρ}_{o} u}{Δ t} \\ {u}_{0} = 0 \qquad Eq . ( 28 )$$

where α is an under-relaxation factor, VOFs is the solid volume fraction, and u₀ is the prescribed velocity to the solid boundary. Since the deposit is assumed to be an immobile porous structure, this velocity should be zero.

### Results

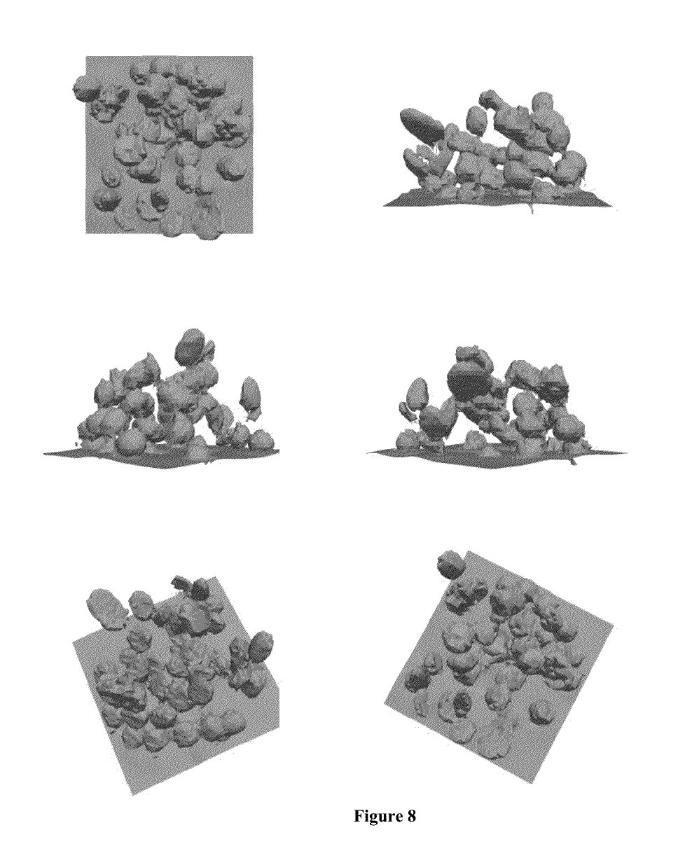

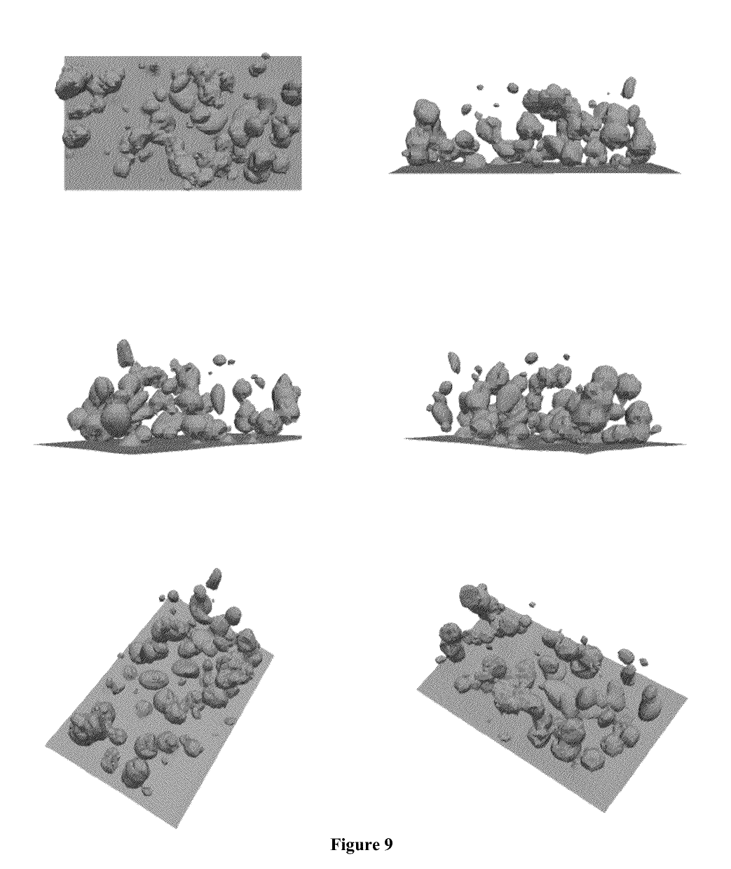

In order to evaluate the method described herein, a test case is presented to qualitatively describe the wax layer buildup on the bottom wall of a channel and to resolve the resulting meso-scale porous structure. The computational domain has dimensions [0,0.005]×[0,0.005]×[0,0.005](m) with resolution 4×4×4 equidistant grid cells in the flow solver. Level set tracking may be performed on the same computational domain using a refined RLSG mesh of size 32×32×32 grid points. 50 Lagrangian particles fill the flow solver domain randomly with a prescribed initial velocity normal towards the bottom wall of v=10 m/s. As the simulation progresses, these particles grow and are transferred from the Lagrangian representation to the level set description. The particles move towards the bottom wall until they touch the bottom wax layer interface, becoming a joint continuous structure, triggering the zero velocity extension to the newly attached particle. FIGS. 8-9 show the structure that the particle agglomeration forms on the wall, which qualitatively depicts a porous gel layer. Simulations with smaller particles distributed randomly throughout the entire domain and strong cross flow in the channel flow direction may also be employed to represent the wax deposition phenomena.

### Code Infrastructure

Simulations were performed using an existing code infrastructure that has been successfully applied to large scale, detailed simulations of multiphase flow dynamics during primary atomization. The code infrastructure comprises the semi-implicit flow solver NGA containing a Lagrangian solver for evaporating, atomizing liquid drops, the RLSG solver LIT, and the dedicated parallel code coupling library CHIMPS. All codes are designed for massively parallel computer systems and scale well to thousands of processors. Details of the code coupling procedures can be found in Herrmann.

### Simulation Tasks

Task 1: Enhanced Lagrangian Particle Model for Crystallite Growth and Collision

The existing flow solver NGA comprises a Lagrangian particle model for evaporating and atomizing liquid drops with full two-way momentum, mass, and species coupling to the Eulerian flow field. This model was enhanced to account for particle growth due to crystallization and particle collisions. Models were incorporated for sticking/rebound of particles colliding with particles, the tracked solid/liquid phase interface, and the pipe wall.

### Data Analysis and Comparisons

Mechanisms of Wax Deposition

The importance of particulate deposition was evaluated from the simulations. The meso-scale simulation data contains detailed information of suspended wax crystallite distribution and deposited wax morphology. Contributions from particulate deposition, precipitation on solid/liquid interface (molecular diffusion mechanism) were measured. The microstructure evolution and the mass content of the wax in the gel layer were followed in the simulations, which provided the aging history of the gel layer.

### Wax Layer Growth Profiles in Space and Time

The growth profiles of the deposit were directly obtained from the proposed simulations.

### Implementation of a Method for Simulation According to One Embodiment

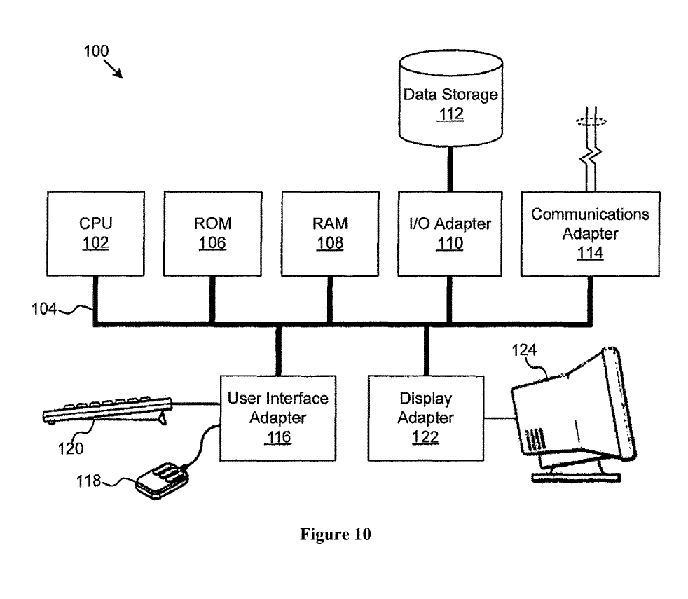

FIG. 10 is a schematic block diagram illustrating one embodiment of a computer system that may be used in accordance with certain embodiments of the system for simulating wax deposition according to one embodiment of the disclosure. A computer system 100 may be adapted according to certain embodiments to perform the simulations and execute the methods described herein. A central processing unit (CPU) 102 may be coupled to a system bus 104. The CPU 102 may be a general purpose CPU or microprocessor. The present embodiments are not restricted by the architecture of the CPU 102, so long as the CPU 102 supports the modules and operations as described herein. The CPU 102 may execute the various logical instructions according to the present embodiments. For example, the CPU 102 may execute machine-level instructions according to the exemplary operations described herein.

The computer system 100 also may include random access memory (RAM) 108, which may be SRAM, DRAM, SDRAM, or the like. The computer system 100 may utilize RAM 308 to store the various data structures used by a software application configured to perform flow simulations. The computer system 100 may also include read only memory (ROM) 106, which may be PROM, EPROM, EEPROM, or the like. The ROM 106 may store configuration information for booting the computer system 100 or code for executing simulations. The RAM 308 and the ROM 306 may collectively store user and system data.

The computer system 100 may also include an input/output (I/O) adapter 110, a communications adapter 114, a user interface adaptor 116, and a display adapter 122. The I/O adapter 110 and/or the user interface adapter 116 may, in certain embodiments, enable a user to interact with the computer system 100 in order to input information for authenticating a user, identifying an individual, or receiving parameters for a simulation. In a further embodiment, the display adapter 122 may display a graphical user interface associated with a software or web-based application for simulating waxy deposits.

The I/O adapter 110 may connect to one or more storage devices 312, such as one or more of a hard drive, a compact disc (CD) drive, a floppy disk drive, a tape drive, to the computer system 100. The communications adapter 114 may be adapted to couple the computer system 100 to the network 106, which may be one or more of a LAN and/or WAN, and/or the Internet. The user interface adapter 116 couples user input devices, such as a keyboard 120 and a pointing device 118, to the computer system 100. The display adapter 122 may be driven by the CPU 102 to control the display on the display device 124.

The present embodiments are not limited to the architecture of system 100. Rather, the computer system 100 is provided as an example of one type of computing device that may be adapted to perform the functions of server 102 and/or the user interface device 110. For example, any suitable processor-based device may be utilized including, without limitation, personal data assistants (PDAs), computer game consoles, and multi-processor servers. Moreover, the present embodiments may be implemented on application specific integrated circuits (ASICs) or very large scale integrated (VLSI) circuits. In fact, persons of ordinary skill in the art may utilize any number of suitable structures capable of executing logical operations according to the described embodiments.

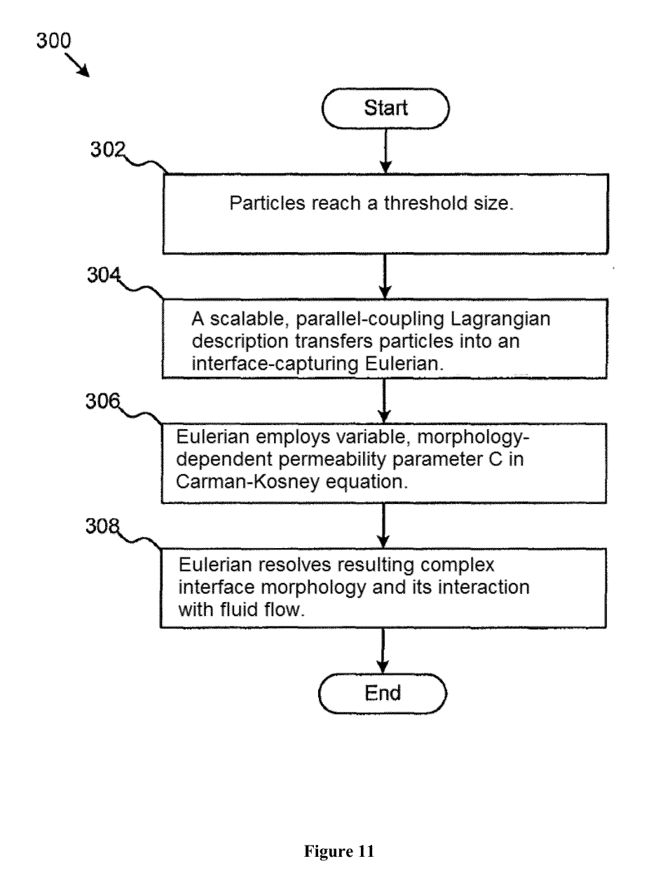

FIG. 11 is a schematic flowchart diagram illustrating one embodiment of a method for simulating wax deposition according to one embodiment of the disclosure. A method 300 may begin at block 302 with particles reaching a threshold size. At block 304, a scalable, parallel-coupling Lagrangian description transfers the particles into an interface-capturing Eulerian. Then, at block 306, the Eulerian employs variable, morphology-dependent permeability parameter C in the Carman-Kosney equation. At block 308, the Eulerian resolves resulting complex interface morphology and its interaction with fluid flow.

If implemented in firmware and/or software, the functions described above, such as with reference to FIG. 11, may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

The claims are not to be interpreted as including means-plus- or step-plus-function limitations, unless such a limitation is explicitly recited in a given claim using the phrase(s) “means for” or “step for,” respectively.

Although the present disclosure and certain of its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

### REFERENCES

The following references are incorporated by reference in their entirety as if set forth in the body of this patent application:
Alonso, J. J., Hahn, S., Ham, F., Herrmann, M., Iaccarino., G., Kalitzin, G., LeGresley, P., Mattsson, K., Medic, G., Moin, P., Pitsch, H., Schluter, J., Svard, M., der Weide, E. V., You, D., & Wu, X. 2006 CHIMPS: A High-Performance Scalable Module for Multi-Physics Simulation. 42^{nd} AIAA/ASME/SAE/ASEE Joint Propulsion Conference \& Exhibit, AIAA-Paper 2006-5274.
Apte, S. V., Mahesh, K., & Lundgren, T. 2008 Accounting for finite-size effects in simulations of disperseparticle-laden flows. International Journal of Multiphase Flow 34, 260-271.
Azevedo, L. F. A., & Teixeira, A. M. 2003 A Critical Review of the Modeling of Wax Deposition Mechanisms. Petroleum Science and Technology, 21, nos. 3 & 4, 393-408.
Banki, R., Hoteit, H. & Firoozabadi, A. 2008 Mathematical Formulation and Numerical Modeling of Wax deposition in Pipelines from Enthalpy-porosity Approach and Irreversible Thermodynamics. Intl. J. Heat & Mass Transfer, 51, 3387-3398.
Brown, T. S., Biesen, V. G., Erickson, D. D. 1993 Measurement and prediction of the kinetics of paraffin deposition. SPE Annual Technical Conference and Eexhibition, Houston, Tex., October 3-6. SPE 26548-MS.
Burger, E. D., Perkins, T. K. & Striegler, J. H. 1981 Studies of Wax Deposition in the Trans Alask Pipeline. J. Petroleum Technology, 33, 1075-1086.
Carslaw, H. S. & Jaeger, J. C. 1959 Conduction of Heat in Solids. 2nd Ed. Oxford Univ. Press. New York.
Creek, J. L., Matzain, B., Apte, M., Volk, M., Delle Case, E. & Lund, H. 1999 Mechanisms for Wax Deposition. AIChE Spring National Meeting, Houston, Tex., March.
Desjardins, O., Blanquart, G., Balarac, G., & Pitsch, H. 2008 High order conservative finite difference scheme for variable density low Mach number turbulent flows. J. Comput. Phys. 227, 7125-7159.
Elphingston, G. M., Greenhill, K. L. & Hsu, J. J. C. 1999 Modeling of Multiphase Wax Deposition. J. Energy Res. Technol. 121(2), 81-85.
Fast, P. & Shelley, M. J. 2004 A moving overset grid method for interface dynamics applied to non-Newtonian Hele-Shaw flow. J. Comput. Phys. 195, 117-142.
Ghosh, M. & Bandyopadhyay, S. 2005 Studies on the crystal growth of rice bran wax in a hexane medium. J. Am. Oil Chem. Soc. 82, 229-231.
Hamouda, A. A. & Davidson, S. 1995 An Approach for Simulation of Paraffin Deposition in Pipelines as a Function of Flow Characteristics with reference to Tesside Oil Pipeline. Proceedings of the SPE International Symposium on Oilfield Chemistry. SPE 28966-MS.
Hecht, U., Granasy, T., Pusztai, B., Bottger, M., Apel, V., Witusiewicz, L., Ratke, J., De Wilde, L., Froyen, D., Camel, B., Drevet, G., Faivre, S. G., Fries, B. Legendre, S. R. 2004 Multiphase Solidification in Multicomponent Alloys. Mater. Sci. Eng. R. 46, 1-49.
Herrmann, M. 2008 A balanced force refined level set grid method for two-phase flows on unstructured flow solver grids. J. Comput. Phys. 227, 2674-2706.
Herrmann, M., Brady, J. M. L. P., & Raessi, M. 2008c Thermocapillary Motion of Deformable Drops and Bubbles. CTR Summer Program, Center for Turbulence Research, Stanford Calif., 155-170.
Herrmann, M. 2009 Detailed Numerical Simulations of the Primary Atomization of a Turbulent Liquid Jet in Crossflow. Proceedings ASME Turbo Expo 2009: Power for Land, Sea and Air, GT2009-59563.
Herrmann, M. 2009b, A Parallel Eulerian Interface Tracking/Lagrangian Point Particle Multi-Scale Coupling Procedure, submitted to J. Comput. Phys.
Hernandez, O. C., Hensley, H., Sarica, C., Brill, J. P., Volk, S.P.E. & Delle-Case, E. 2004 Improvements in Single-Phase Paraffin Deposition Modeling. SPE 84502-PA. SPE Prod. Facil. 19(4), 237-244.
Hoteit, H, Banki, R. & Firoozabadi, A. 2008 Wax Deposition and Aging in Flowlines from Irreversible Thermodynamics. Energy & Fuels, 22, 2693-2706.
Li, H. & Zhang, J. 2003 A Generalized Model for Predicting non-Newtonian Viscosity of Waxy Crudes as a Function of Temperature and Precipitated Wax. Fuel, 82, 1387-1397.
Lira-Galeana, C., Firoozabadi, A. & Prausnitz, J. 1996 Thermodynamics of wax Precipitation in Petroleum Mixtures. AIChE J. 42, 239-248.
Moin, P. & Apte, S. V. 2006 Large-Eddy Simulation of Realistic Gas Turbine Combustors. AIAA J. 44, 698-708.
Pedersen, K. S., 1995 Prediction of cloud point temperature and amount of wax precipitation. SPE Prod. Facil. 10(1), 46-49.
Ramirez-Jaramillo, E., Lira-Galeana, C. & Manero, O. 2004 Modeling Wax deposition in Pipelines. Pet. Sci. Technol. 22(7-8), 821-861.
Singh, P., Venkatesan, R., & Fogler, H. S. 2000 Formation and Aging of Incipient Thin Film Wax-Oil Gels. AIChE J. 46, 1059-1074.
Singh, P., Venkatesan, R., Fogler, H. S. & Nagarajan, N. R. 2001 Morphological Evolution of Thick Wax Deposits During Aging. AIChE J. 47, 6-18.
Svendsen, J. A. 1993 Mathematical Modeling of Wax Deposition in Oil Pipeline Systems. AIChE J. 39(8), 1377-1388.
Weingarten, J. S., Euchner, J. A. 1988 Methods for predicting Wax precipitation and deposition. SPE 15654-PA. SPE Prod. Eng. 3(1), 121-126.
Won, K. W., 1986 Thermodynamics for solid solution-liquid-vapor equilibria: wax phase formation from heavy hydrocarbon mixtures. Fluid Phase Equilibria, 30, 265-279.
Won, K. W., 1989 Thermodynamic calculation of cloud point temperatures and wax phase compositions of refined hydrocarbon mixtures. Fluid Phase Equilibria, 53, 337-396.

1. A multi-scale coupling method for the formation and aging process of a deposit, which involves a phase change on a level set-tracked solid/liquid interface and motion and growth of solid particles suspended in fluid flow using a processor, comprising,
using a scalable, parallel-coupling Lagrangian description to capture submicro-micro scale particles using particle-particle, particle-wall, and particle-interface collision models to describe interaction between Lagrangian particles, particle-wall, and particle-level set tracked interface using a transfer algorithm to migrate the particle; and
once they have reached a threshold size, transfer into an interface-capturing Eulerian description that resolves the resulting complex interface morphology and its interaction with the fluid flow.

2. The method of claim 1, wherein the multi-scale method comprises a micro-scale, a meso-scale, and a macro scale.

3. The method of claim 2, wherein particle evolution and the formation and aging of immobile porous deposit against the pipe wall at the micro- and meso-scales are coupled with bulk fluid flow at the macro-scale.

4. The method of claim 1, wherein a morphology-dependent permeability parameter, C, in a Carman-Kosney equation is computed and evolved in time from the meso-scale simulation.

5. The method of claim 1, wherein the growth of solid particles simulates the growing microstructure of wax precipitation particulates or asphaltene aggregates.

6. The method of claim 1, wherein the multi-scale coupling method enables predictive modeling of deposition processes in fluid flows.

7. The method of claim 1, wherein the particle threshold size is reached through precipitation growth.

8. The method of claim 1, wherein the particle threshold size is reached through agglomeration.

9. The method of claim 1, wherein the multi-scale coupling method enables detailed predictive simulations of precipitation growth on a solid/liquid interface.

10. The method of claim 8 wherein the multi-scale coupling method enables detailed predictive simulations of agglomeration formation.

11. The method of claim 1, wherein the multi-scale coupling method enables detailed predictive simulations of deposition processes of precipitated solids and/or agglomerations on boundaries exposed to fluid flow.

12. The method of claim 11, wherein the precipitated solids and/or agglomerations comprise wax crystals and/or asphaltenes.

13. The method of claim 1, wherein the growth of solid particles is simulated in the presence of heat transfer.

14. The method of claim 1, wherein the growth of solid particles provides information on the wax content.

15. The method of claim 1, wherein the growth of solid particles provides information on wax aging.

16. The method of claim 1, wherein the multi-scale method reflects physical phenomena occurring at multiple length scales in wax deposition.

17. The method of claim 1, wherein the method provides information for elucidating wax deposition mechanisms.

18. The method of claim 1, wherein an aging process is simulated by computing a growing microstructure from precipitation processes and particulate deposition.

19. The method of claim 18, wherein the growing microstructure is used to compute permeability of a gel layer by volume averaging.

20. The method of claim 1, wherein the particle evolution at the micro- and meso-scales includes interactions of particle-particle, particle-wall, and particle-interface.

21. The method of claim 1, wherein the multi-scale coupling method enables predictive modeling of particle evolution.

22. The method of claim 1, wherein the multi-scale coupling method enables predictive modeling of particle evolution

23. The method of claim 1, wherein the precipitation occurring is simulated in the presence of heat transfer.

24. The method of claim 1, wherein the precipitation is due to the temperature gradient in the fluid.

25. The method of claim 1, wherein the precipitation initiates molecular diffusion, and additional precipitation.

26. The method of claim 1, wherein the precipitation provides information on the wax content.

27. The method of claim 1, wherein the precipitation provides information on wax aging.

28. The method of claim 1, wherein precipitation rate in increased to force a time scale of the phase change process.
